(19) United States
(12) Patent Application Publication
(10) Pub. No.: US 2012/0304105 A1
(43) Pub. Date: Nov. 29, 2012

(54) Wiring Diagram Visualization System

(75) Inventors: Monica C. Rosman LaFever, Renton, WA (US); Patrick J. Eames, Newcastle, WA (US); Brent Louis Hadley, Kent, WA (US)

(73) Assignee: THE BOEING COMPANY, Chicago, IL (US)

(21) Appl. No.: 13/116,198

(22) Filed: May 26, 2011

(51) Int. Cl. G06F 3/048

(52) U.S. Cl. 715/781

(57) ABSTRACT

A method and apparatus for displaying wiring information. A first view of a wiring system is displayed in which logical components are displayed in the first view. A second view of the wiring system is displayed in which physical components in the wiring system are displayed in the second view. Responsive to a user input to a display of the wiring system in one view from the first view and the second view, a reaction in another view other than the one view from the first view and the second view is displayed based on the user input to the display of the wiring system.

### BACKGROUND INFORMATION

1. Field

The present disclosure relates generally to wiring diagrams and, in particular, to displaying wiring diagrams. Still more particularly, the present disclosure relates to a method and apparatus for displaying multiple views of wiring systems in wiring diagrams.

2. Background

Structures such as aircraft may have hundreds of miles of wiring in a wiring system. The wiring system may be used to carry power and data to different components in a wiring system in the aircraft. These components may include computers, lights, displays, and other suitable types of devices.

Diagrams illustrating representations of these wiring systems are referred to as schematic diagrams. Schematic diagrams include multiple components. For example, with aircraft, electrical wiring diagrams are used to illustrate all of the conductive paths between various components in the aircraft.

A schematic diagram is typically presented in a hard copy form which may have multiple pages of drawings. In some cases, the schematic diagrams may be depicted in electronic form. These drawings contain large amounts of information about the components in the drawings. These diagrams may include references to other sheets.

Using hardcopy sheets of drawings are very time-consuming and may be difficult for users, such as maintenance personnel. The difficulty may increase when more than one component is referenced, and those components are located on different sheets in the schematic diagram.

For example, maintenance personnel may inspect the wiring in the aircraft. The maintenance personnel may also replace and install wires. In performing maintenance, the inspection of the wiring is often made with the aide of schematic diagrams.

Thus, the different advantageous embodiments take into account at least one of the issues discussed above, as well as possibly other issues.

### SUMMARY

In one advantageous embodiment, a method for displaying wiring information is provided. A first view of a wiring system is displayed in which logical components are displayed in the first view. A second view of the wiring system is displayed in which physical components in the wiring system are displayed in the second view. Responsive to a user input to a display of the wiring system in one view from the first view and the second view, a reaction in another view other than the one view from the first view and the second view is displayed based on the user input to the display of the wiring system.

In another advantageous embodiment, an apparatus comprises a computer system. The computer system is configured to display a first view of a wiring system in which logical components are displayed in the first view. The computer system is further configured to display a second view of the wiring system in which physical components in the wiring system are displayed in the second view. Responsive to a user input to a display of the wiring system in one view from the first view and the second view, the computer is system is configured to display a reaction in another view other than the one view from the first view and the second view based on the user input to the display of the wiring system.

In yet another advantageous embodiment, a computer program product comprises a computer readable storage medium, first program code, second program code, and third program code. The first program code is for displaying a first view of a wiring system in which logical components are displayed in the first view. The second program code is for displaying a second view of the wiring system in which physical components in the wiring system are displayed in the second view. The third program code, responsive to a user input to a display of the wiring system in one view from the first view and the second view, is for displaying a reaction in another view other than the one view from the first view and the second view based on the user input to the display of the wiring system. The first program code, the second program code, and the third program code are stored on the computer readable storage medium.

The features, functions, and advantages can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the advantageous embodiments are set forth in the appended claims. The advantageous embodiments, however, as well as a preferred mode of use, further objectives and advantages thereof, will best be understood by reference to the following detailed description of an advantageous embodiment of the present disclosure when read in conjunction with the accompanying drawings, wherein:

FIG. 1 is an illustration of a wiring display environment in accordance with an advantageous embodiment;

FIG. 2 is an illustration of a display module in accordance with an advantageous embodiment;

FIG. 3 is an illustration of graphics data in accordance with an advantageous embodiment;

FIG. 4 is an illustration of a first view and a second view of a wiring system in accordance with an advantageous embodiment;

FIG. 5 is an illustration of interaction between two views of a wiring system in accordance with an advantageous embodiment;

FIG. 6 is another illustration of interaction between two views of a wiring system in accordance with an advantageous embodiment;

FIG. 7 is another illustration of interaction between two views of a wiring system in accordance with an advantageous embodiment;

FIG. 8 is another illustration of interaction between two views of a wiring system in accordance with an advantageous embodiment;

FIG. 9 is an illustration of a flowchart of a process for displaying wiring information in accordance with an advantageous embodiment; and

FIG. 10 is an illustration of a data processing system in accordance with an advantageous embodiment.

### DETAILED DESCRIPTION

The different advantageous embodiments recognize and take into account a number of considerations. “A number”, as used herein with reference to items, means one or more items. For example, “a number of considerations” is one or more considerations.

For example, the different advantageous embodiments recognize and take into account that although diagrams of wiring systems may be displayed electronically on a display screen, the amount of information in these diagrams may still increase the time and effort needed by a maintenance person to find information needed by the maintenance person to perform maintenance operations.

For example, a drawing in a schematic diagram may include hundreds of components. Finding a component of interest may take more time and effort than desired by a maintenance person. If the maintenance person is looking for a particular wiring bundle within a wiring system of an aircraft, the time needed to find that particular wiring bundle, trace or locate the wiring bundle, and find the path of the wiring bundle may be more difficult than desired.

The different advantageous embodiments recognize and take into account that one manner in which a particular component may be more easily identified is through the use of graphical indicators. A graphical indicator may be used to highlight the desired wiring bundle when a user input is received selecting the wiring bundle. The different advantageous embodiments recognize and take into account that even with this type of graphical indicator, the drawings may include other information that is not needed by the maintenance operator. The maintenance operator may still need to look for other components related to the wiring bundle to perform an inspection or other maintenance operations.

Thus, the different advantageous embodiments provide a method and apparatus for displaying wiring information. A first view of a wiring system is displayed in which logical components are displayed in the first view. A second view of the wiring system is displayed in which the physical components of the wiring system are displayed in the second view. In response to a user input to the display of the wiring system in one view in one of the first view and second view, a reaction is displayed in another view in the first view and the second view based on the user input to the component.

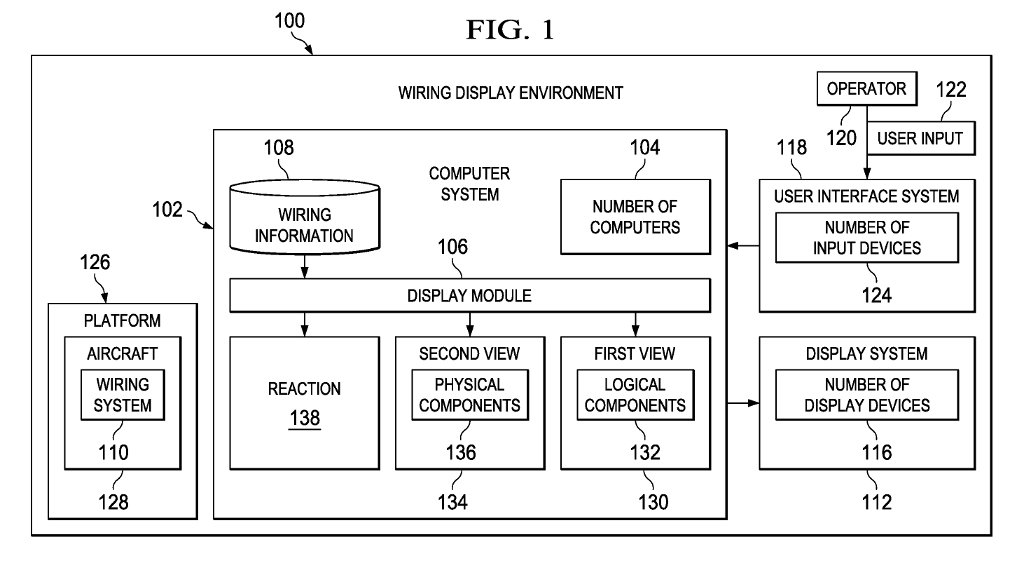

With reference now to the figures and, in particular, with reference now to FIG. 1, an illustration of a wiring display environment is depicted in accordance with an advantageous embodiment. In this depicted example, wiring display environment 100 comprises computer system 102.

Computer system 102 includes number of computers 104. When more than one computer is present in number of computers 104, those computers may be in communication with each other through a network, wireless communications links, or other suitable types of communication systems.

In these illustrative examples, display module 106 is located in computer system 102. Display module 106 may be implemented using software, hardware, or a combination of the two. In these illustrative examples, display module 106 displays wiring information 108 for wiring system 110 in display system 112. Wiring system 110 is comprised of components. The components may be at least one of modules, line-replaceable units, computers, display devices, lights, wires, connectors, power sources, buses, switches, plugs, brackets, and/or other suitable types of components.

As used herein, the phrase “at least one of”, when used with a list of items, means that different combinations of one or more of the listed items may be used and only one of each item in the list may be needed. For example, “at least one of item A, item B, and item C” may include, for example, without limitation, item A, or item A and item B. This example also may include item A, item B, and item C, or item B and item C.

Display system 112 is a hardware system and may comprise number of display devices 116. Number of display devices 116 may comprise a liquid crystal display device, a projector, and/or other suitable types of display devices.

Further, user interface system 118 also may be present in computer system 102. User interface system 118 may be implemented using hardware, software, or a combination of the two. User interface system 118 allows operator 120 to provide user input 122 to interact with display module 106. User input 122 may be used to manipulate or view wiring information 108.

In these illustrative examples, user interface system 118 comprises number of input devices 124. Number of input devices 124 may be, for example, without limitation, at least one of a mouse, a keyboard, a touch screen, a gesture detection system, and other suitable types of input devices.

Wiring system 110, in these illustrative examples, is in platform 126. Platform 126 may take various forms. For example, platform 126 may be aircraft 128.

Wiring system 110 may be, for example, for an entertainment system, an environmental system, and/or other types of systems that may be found within aircraft 128. In other words, wiring system 110 may be one or more of the different systems through which electricity flows.

In these illustrative examples, display module 106 generates and displays first view 130 of wiring system 110 in which logical components 132 in wiring system 110 are displayed in first view 130. Additionally, display module 106 generates and displays second view 134 of wiring system 110 in which physical components 136 are displayed in second view 134.

In these illustrative examples, logical components 132 are logical representations of physical components 136. Logical components 132 may be displayed as blocks, logic symbols, or graphics. Logical components 132 may represent functions or components without regard to their physical form in the display in first view 130.

Physical components 136 in second view 134 are physical representations of components in wiring system 110. In other words, physical components 136 are displayed as graphics of how these components in wiring system 110 would look when viewed in aircraft 128 by operator 120.

In response to user input 122 to the display of wiring system 110 in one view selected from first view 130 and second view 134, reaction 138 is identified and displayed in another view from first view 130 and second view 134. Display module 106 generates reaction 138 based on user input 122 to wiring system 110.

In these illustrative examples, reaction 138 is an alteration of a display of the components in wiring system 110 in the view in which user input 122 was not received. In other words, when user input 122 is made to the display of wiring system 110 in one of the views, reaction 138 is displayed in the other view. In this manner, interaction occurs between first view 130 and second view 134.

The illustration of wiring display environment 100 in FIG. 1 is not meant to imply physical or architectural limitations to the manner in which an advantageous embodiment may be implemented. Other components in addition to, and/or in place of, the ones illustrated may be used. Some components may be unnecessary. Also, the blocks are presented to illustrate some functional components. One or more of these blocks may be combined and/or divided into different blocks when implemented in an advantageous embodiment.

In some illustrative examples, additional views may be presented. For example, physical components 136 may be displayed in another view in which physical components 136 are displayed in two dimensions rather than three dimensions.

Although an advantageous embodiment has been described with respect to aircraft, the advantageous embodiment may be applied to other types of platforms. For example, without limitation, other advantageous embodiments may be applied to a mobile platform, a stationary platform, a land-based structure, an aquatic-based structure, a space-based structure, and/or some other suitable object. More specifically, the different advantageous embodiments may be applied to, for example, without limitation, a submarine, a bus, a personnel carrier, tank, a train, an automobile, a spacecraft, a space station, a satellite, a surface ship, a power plant, a dam, a manufacturing facility, a building, and/or some other suitable object.

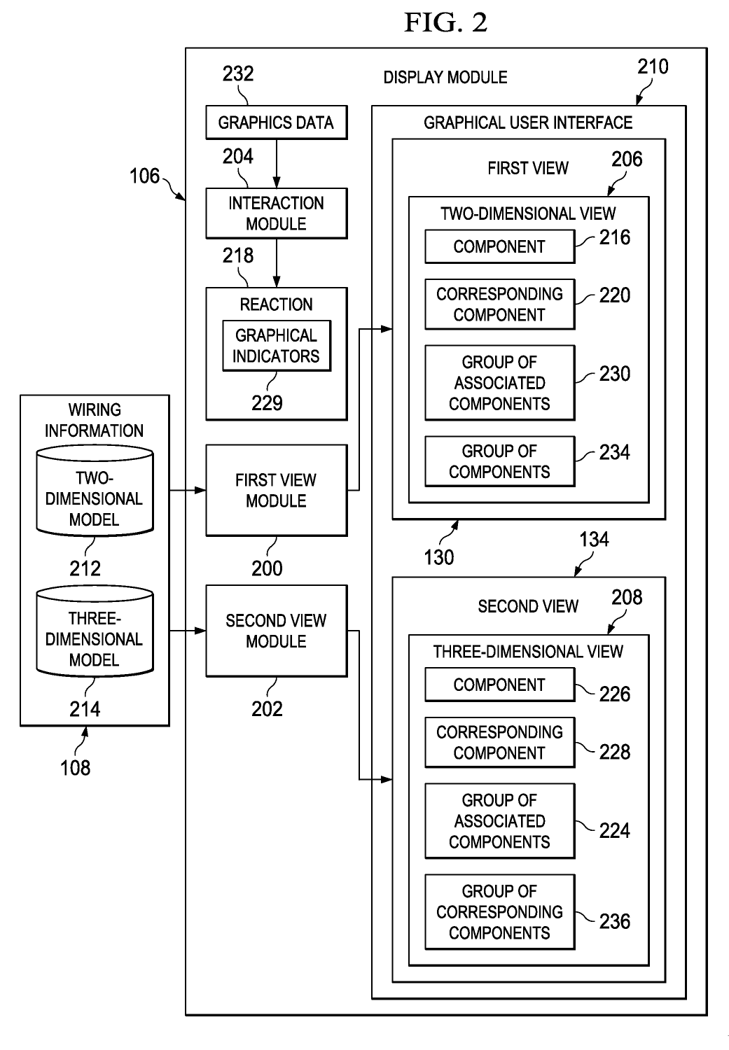

With reference now to FIG. 2, an illustration of a display module is depicted in accordance with an advantageous embodiment. As depicted, one example of display module 106 is depicted.

Display module 106, as illustrated, comprises first view module 200, second view module 202, and interaction module 204. In these illustrative examples, first view module 200 generates first view 130 for display on display system 112 in FIG. 1. Second view module 202 generates second view 134 for display on display system 112.

In these illustrative examples, first view 130 is two-dimensional view 206, while second view 134 is three-dimensional view 208. These views are displayed in graphical user interface 210 in these illustrative examples.

Two-dimensional view 206 and three-dimensional view 208 are generated by first view module 200 and second view module 202 using wiring information 108. Wiring information 108 may be stored in a group of databases. “A group”, as used herein with reference to items, means one or more items. For example, “a group of databases” means one or more databases. In these illustrative examples, wiring information 108 may take the form of computer-aided design (CAD) drawings and/or other suitable information.

In these illustrative examples, wiring information 108 includes two-dimensional model 212 and three-dimensional model 214. Two-dimensional model 212 contains information needed to generate two-dimensional view 206 of wiring system 110 in FIG. 1. Three-dimensional model 214 comprises information needed to generate three-dimensional view 208 of wiring system 110. These models may take the form of any currently-used models for displaying two-dimensional and three-dimensional drawings on a computer system. For example, the models may be computer-aided design models or other types of models.

In these illustrative examples, two-dimensional view 206 is a graphical representation of components in wiring system 110. The graphical representation does not include the physical view or details of the components. The representation may be made using blocks, symbols, and/or other graphics. For example, two-dimensional view 206 may display wires, equipment, and/or other components.

Three-dimensional view 208 provides a graphical representation of the physical layout of different components in a physical form. In three-dimensional view 208, wiring system 110 is displayed with a representation of the physical bundles, wires, and other equipment in three-dimensional space. Three-dimensional view 208 may describe or show the entire path that electrical signals may take from point to point within wiring system 110. Groupings of components into functionality are not shown in three-dimensional view 208.

In the illustrative examples, two-dimensional view 206 and three-dimensional view 208 each provide different types of information about wiring system 110. Two-dimensional view 206 does not include all of the information presented by three-dimensional view 208. In a similar fashion, three-dimensional view 208 does not provide all of the information seen in two-dimensional view 206. For example, two-dimensional view 206 may provide information about components, functions, and/or other suitable information.

In contrast, three-dimensional view 208 may provide information about the physical location or routing of components in wiring system 110. Further, three-dimensional view 208 may provide information about support structures and/or other devices in wiring system 110 that may not have corresponding logical components for display in two-dimensional view 206. Components, such as wiring bundles, boxes, and connectors in the physical design of wiring system 110 may not be seen in two-dimensional view 206.

In summary, two-dimensional view 206 provides a graphical representation of components needed to describe a function of a system but has no physical information. For example, only selected wires may be shown and other connectors and components may not be present in this view depending on the particular implementation. Information about wire gauge, length, physical location, and routing of the wires in wiring bundles are not present in two-dimensional view 206.

In contrast, three-dimensional view 208 provides a graphical representation of the components in their physical form. Three-dimensional view 208 also may include the location and routing of the different components. For example, a wiring bundle or tube may contain wires from various functions and systems. Three-dimensional view 208 shows this wiring bundle but may not show the wires inside of the wiring bundle. In contrast, two-dimensional view 206 may only show wires for a particular function, depending on the filtering or selection of wiring system 110.

In other words, a one-to-one correspondence between a component in two-dimensional view 206 and three-dimensional view 208 may not always be present. However, although a one-to-one correspondence may not be present, a correspondence or association between components may still be made. For example, an association between a wire in two-dimensional view 206 may be made with a wiring bundle in three-dimensional view 208.

In these illustrative examples, interaction module 204 provides interaction between first view 130 and second view 134. Interaction module 204 may receive user input 122 from operator 120 through number of input devices 124.

For example, user input 122 to component 216 in two-dimensional view 206 in first view 130 results in reaction 218 being displayed in three-dimensional view 208 in second view 134. Reaction 218 may take various forms. For example, reaction 218 may be with respect to corresponding component 228 for component 216. Component 216 may be a wire in two-dimensional view 206. Corresponding component 228 may be the corresponding wire in three-dimensional view 208. In particular, reaction 218 may be displayed in graphical user interface 210 in the form of graphical indicators 229.

In some illustrative examples, if corresponding component 228 is not present in three-dimensional view 208, then group of associated components 224 may be the subject of reaction 218.

Reaction 218 may be to associate a graphical indicator from graphical indicators 229 with corresponding component 228 and/or group of associated components 224. The graphical indicator may be highlighting, changing a color of a component, display of an icon by a component or on a component, bolding of lines, and/or other suitable types of graphical indicators.

A graphical indicator may be associated with a component in a number of different ways. A graphical indicator is associated with a component when a viewer of graphical user interface 210 knows that the graphical indicator is for the particular component.

For example, group of associated components 224 may be a wiring bundle if the wire selected in two-dimensional view 206 is not shown in three-dimensional view 208. With the selection of the wire as component 216, the wiring bundle in which component 216 is located is displayed in association with a graphical indicator. In this example, the wiring bundle is corresponding component 228.

In a similar fashion, if the user input to wiring system 110 is to select component 226 in three-dimensional view 208, reaction 218 may be highlighting of corresponding component 220 and/or group of associated components 230 in two-dimensional view 206.

In this example, the selection of a wiring bundle for component 226 may result in one or more wires being highlighted in two-dimensional view 206 as group of associated components 230. The wires are associated with the bundle because they are located in the wiring bundle in this illustrative example. As discussed above, this association of components may be made using graphics data 232.

In still other illustrative examples, the user input to wiring system 110 may be to a group of components. For example, user input 122 may be to select or filter two-dimensional view 206 to only show a portion of wiring system 110. This filtering may be to show portions of wiring system 110 for a particular function and/or system in wiring system 110.

For example, if wiring system 110 is for all of aircraft 128, the selection of group of components 234 in two-dimensional view 206 may be for components in the environmental system within the wiring system. In a similar fashion, group of corresponding components 236 displayed in three-dimensional view 208 will result in showing only those components selected for the environmental system in two-dimensional view 206.

As another illustrative example, if the selection of group of components 234 in two-dimensional view 206 are for an entertainment system, then reaction 218 in three-dimensional view 208 is to display group of associated components 224 that include the components for the entertainment system. Of course, other types of filtering may be used depending on the particular implementation.

In these illustrative examples, the association between logical components 132 displayed in two-dimensional view 206 and physical components 136 displayed in three-dimensional view 208 is made using graphics data 232. Graphics data 232 provides an association between the different components in two-dimensional model 212 and three-dimensional model 214.

As discussed above, this correspondence may not be component to component, but in some cases, a component may correspond to a group of components or a different component. In other cases, a group of components may correspond to a single component. For example, a wire may correspond to a wiring bundle while a bundle may correspond to a group of wires.

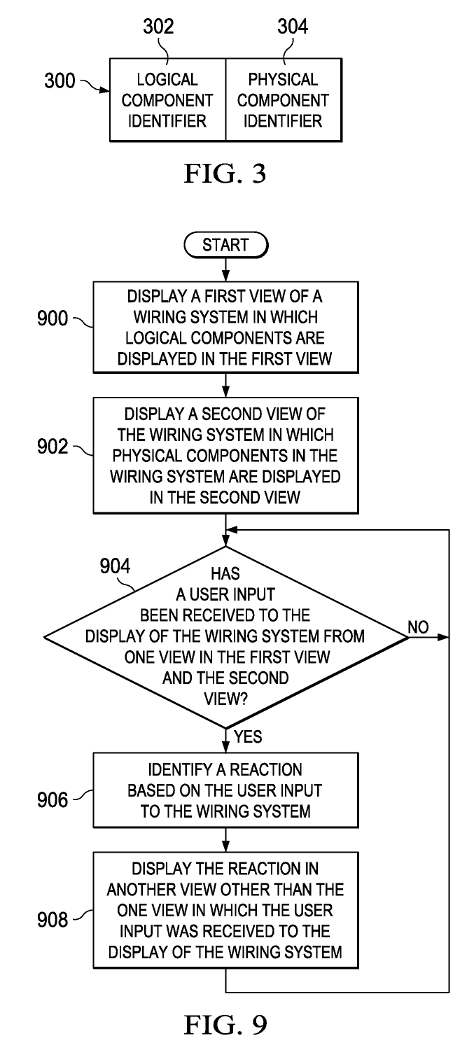

With reference now to FIG. 3, an illustration of graphics data is depicted in accordance with an advantageous embodiment. In this illustrative example, entry 300 is an example of a record or entry in graphics data 232 in FIG. 2. As can be seen, entry 300 comprises logical component identifier 302 and physical component identifier 304.

When one component is selected, the other component is identified in entry 300. The course of the component may not be a corresponding component but may be a group of components associated with the selected component.

For example, if logical component identifier 302 is for a wire, physical component identifier 304 may be for a wire or a wiring bundle in which the wire is located in the corresponding three-dimensional model.

These identifiers correspond to components in two-dimensional model 212 in wiring information 108 in FIG. 2. Physical component identifier 304 corresponds to three-dimensional model 214 in wiring information 108 in FIG. 2.

Logical component identifier 302 may be an identifier used for the component in two-dimensional model 212. Physical component identifier 304 may correspond to an identifier used for the component in three-dimensional model 214. Thus, when particular components in the models are selected in the views, the identifier for the selected component may be used to identify the corresponding component or group of components in the other model.

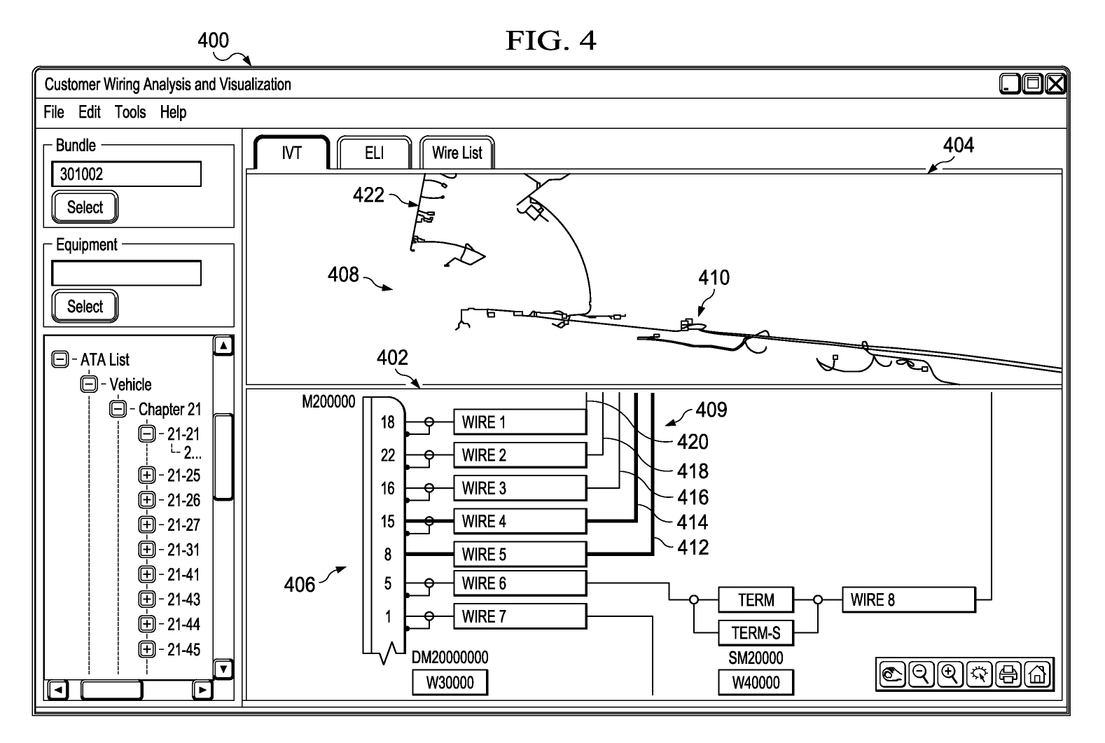

With reference now to FIG. 4, an illustration of a first view and a second view of a wiring system is depicted in accordance with an advantageous embodiment. Graphical user interface 400 is an example of one implementation of graphical user interface 210 shown in block form in FIG. 2. In this illustrative example, graphical user interface 400 includes first view 402 and second view 404. First view 402 takes the form of two-dimensional view 406, while second view 404 takes the form of three-dimensional view 408.

In these illustrative examples, first view 402 is an example of one implementation of first view 130 shown in block form in FIG. 1. Second view 404 is an example of one implementation of second view 134 shown in block form in FIG. 1.

In these illustrative examples, two-dimensional view 406 and three-dimensional view 408 are generated by display module 106 and displayed on display system 112 within computer system 102 in FIG. 1. In these illustrative examples, logical components 409 are displayed in two-dimensional view 406. Physical components 410 in wiring system 110 are displayed in three-dimensional view 408.

In these illustrative examples, some or all of logical components 409 may correspond to some or all of physical components 410. In some cases, some components illustrated in one view may not be present in another view.

For example, wires 412, 414, 416, 418, and 420 are present in wiring bundle 422. Wires 412, 414, 416, 418, and 420 are individually shown in two-dimensional view 406. However, these wires are not individually shown in three-dimensional view 408. Instead, only wiring bundle 422 is illustrated in three-dimensional view 408. Two-dimensional view 406 is not shown in second view 404. Instead, an associated component for wire 412 is displayed. In this example, wiring bundle 422 is a component in three-dimensional view 408 that contains wire 412.

In this illustrative example, a selection of a logical component in logical components 409 in two-dimensional view 406 causes a display of a graphical indicator to identify the corresponding physical component in physical components 410 in three-dimensional view 408. Similarly, a selection of a physical component in physical components 410 causes a display of a graphical indicator to identify the corresponding logical component in logical components 409 in two-dimensional view 406.

As depicted in this example, the graphical indicators used may include highlighting, a color, and/or other suitable types of graphical indicators. Other examples of graphical indicators include, for example, without limitation, shading, a pattern, a box, a circle, a dashed outline around a component, a balloon, and/or other suitable types of graphical indicators.

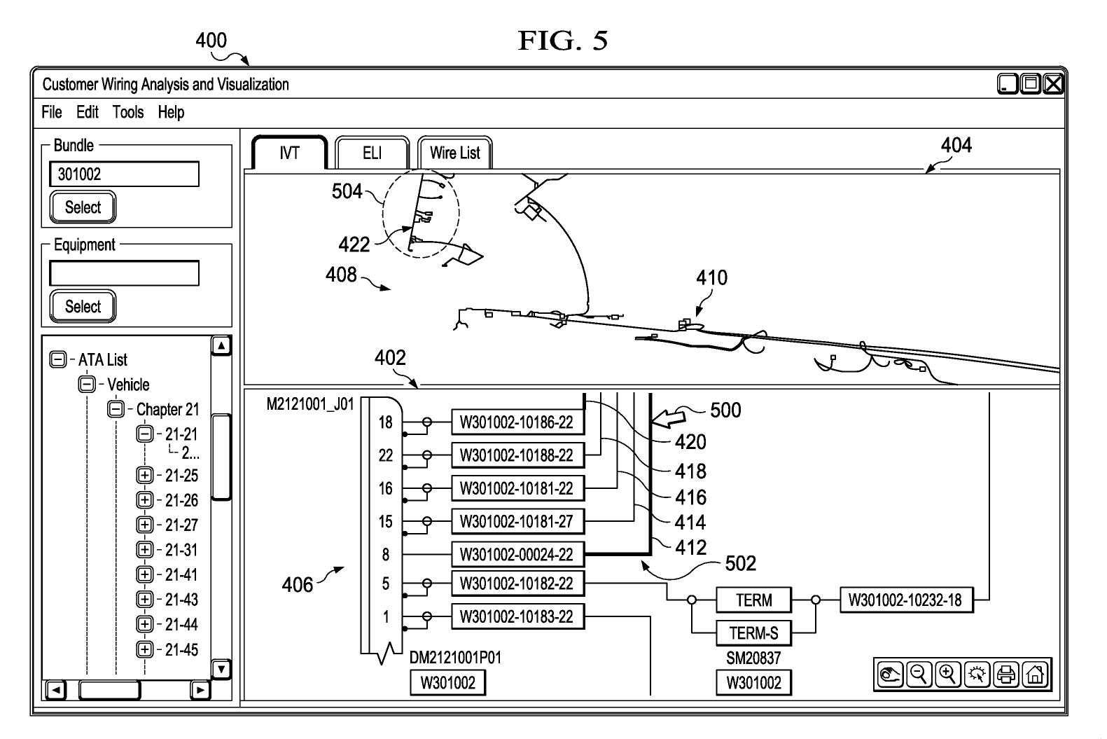

With reference now to FIG. 5, an illustration of interaction between two views of a wiring system is depicted in accordance with an advantageous embodiment. In this illustrative example, pointer 500 has been moved over wire 412, and wire 412 has been selected by user input 122.

In response to a selection of wire 412, graphical indicator 502 is associated with wire 412. In this example, graphical indicator 502 is a thicker line displayed for wire 412. Of course, other types of graphical indicators may be used, such as highlighting, color, flashing, graphics, an icon, and/or other suitable types of indicators.

In addition, wiring bundle 422 is also highlighted in this illustrative example. The reaction in this example is an association of graphical indicator 504 with wiring bundle 422. In this example, graphical indicator 504 is a dashed line. Wiring bundle 422 corresponds to the wiring bundle in which wire 412 is located.

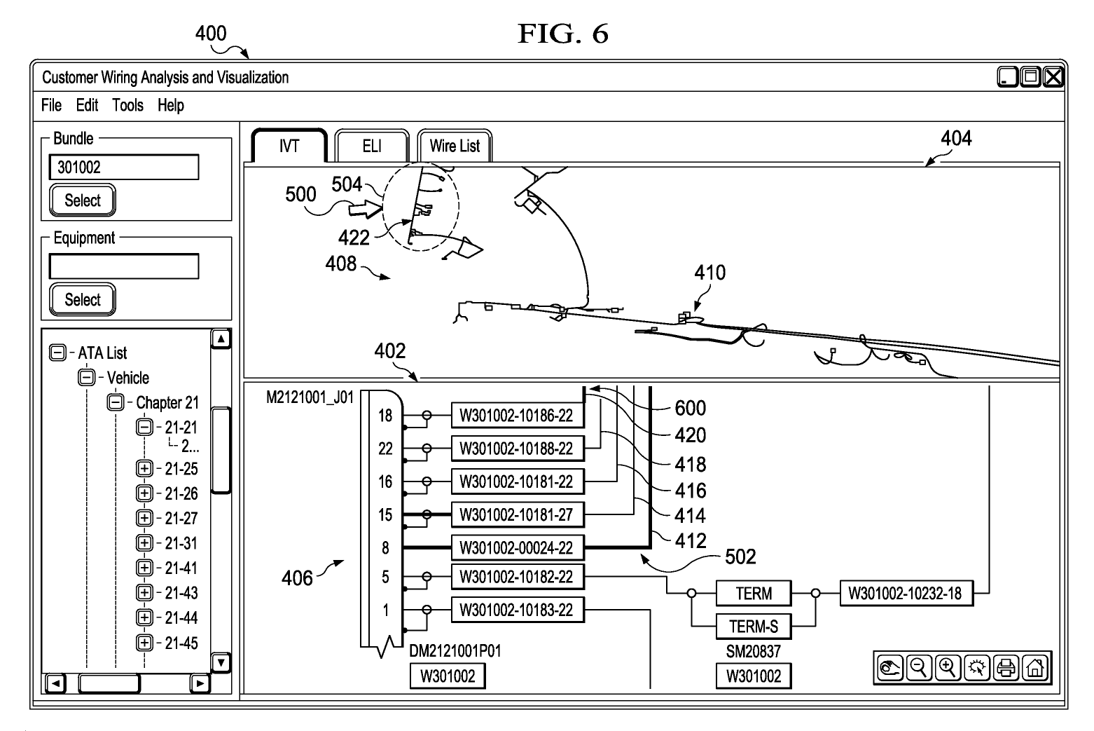

With reference now to FIG. 6, another illustration of interaction between two views of a wiring system is depicted in accordance with an advantageous embodiment. In this illustrative example, pointer 500 has been moved over wiring bundle 422. Additionally, wiring bundle 422 has been selected.

In response to a selection of wiring bundle 422, wiring bundle 422 is associated with graphical indicator 504. Additionally, wires 412 and 420 are also associated with graphical indicators.

In particular, wire 412 is associated with graphical indicator 502 and wire 420 is associated with graphical indicator 600. Both graphical indicator 502 and graphical indicator 600 are thicker lines for the display of wire 412 and wire 420, respectively. These wires are associated with graphical indicators 502 and 600 as a reaction to the selection of wiring bundle 422. These wires are inside of wiring bundle 422 in the depicted examples.

As depicted, wires 414, 416, and 418 are not associated with the graphical indicator in this illustrative example. Although these wires are part of the same function, they are not present inside of wiring bundle 422 in this example. These wires are located in other wiring bundles or in other locations in these illustrative examples.

The illustration of graphical user interface 400 with two-dimensional view 406 and three-dimensional view 408 is not meant to imply limitations to the manner in which different advantageous embodiments may be implemented. For example, graphical user interface 400 displays two-dimensional view 406 and three-dimensional view 408 in a single window. In other illustrative examples, each view may be displayed in a separate window. Further, graphical indicators are associated with the components in this example. In particular, one graphical indicator is associated with each component.

In other illustrative examples, multiple graphical indicators may be used. For example, highlighting and flashing, color and line thickness, dashed lines and icons, and/or other suitable types of combinations of graphical indicators may be used. In other words, any type or number of graphical indicators may be used with the components to identify the components that correlate with each other in the two different views.

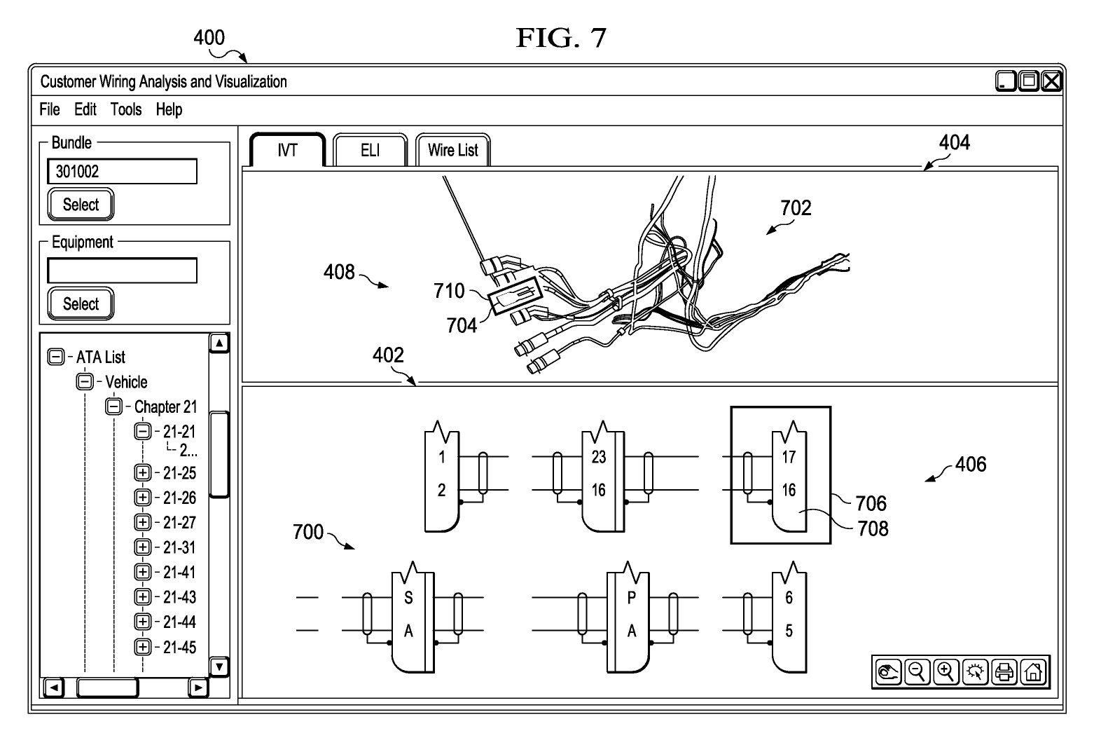

With reference now to FIG. 7, another illustration of interaction between two views of a wiring system is depicted in accordance with an advantageous embodiment. In this illustrative example, logical components 700 are displayed in two-dimensional view 406 in graphical user interface 400. Physical components 702 are displayed in three-dimensional view 408.

As depicted, in this illustrative example, a selection of physical component 704 in three-dimensional view 408 causes a display of graphical indicator 706 in two-dimensional view 406. Graphical indicator 706 identifies logical component 708 as corresponding to physical component 704. Graphical indicator 706 takes the form of a box around logical component 708 in this illustrative example.

Similarly, a selection of logical component 708 causes a display of graphical indicator 710 in three-dimensional view 408. Graphical indicator 710 identifies physical component 704 as corresponding to logical component 708. In this illustrative example, graphical indicator 710 takes the form of a pattern for physical component 704.

In this manner, two-dimensional view 406 and three-dimensional view 408 may interact with each other. In some illustrative examples, a selection of a logical component in logical components 700 in two-dimensional view 406 may cause a number of graphical indicators that identify one or more physical components associated with the logical component.

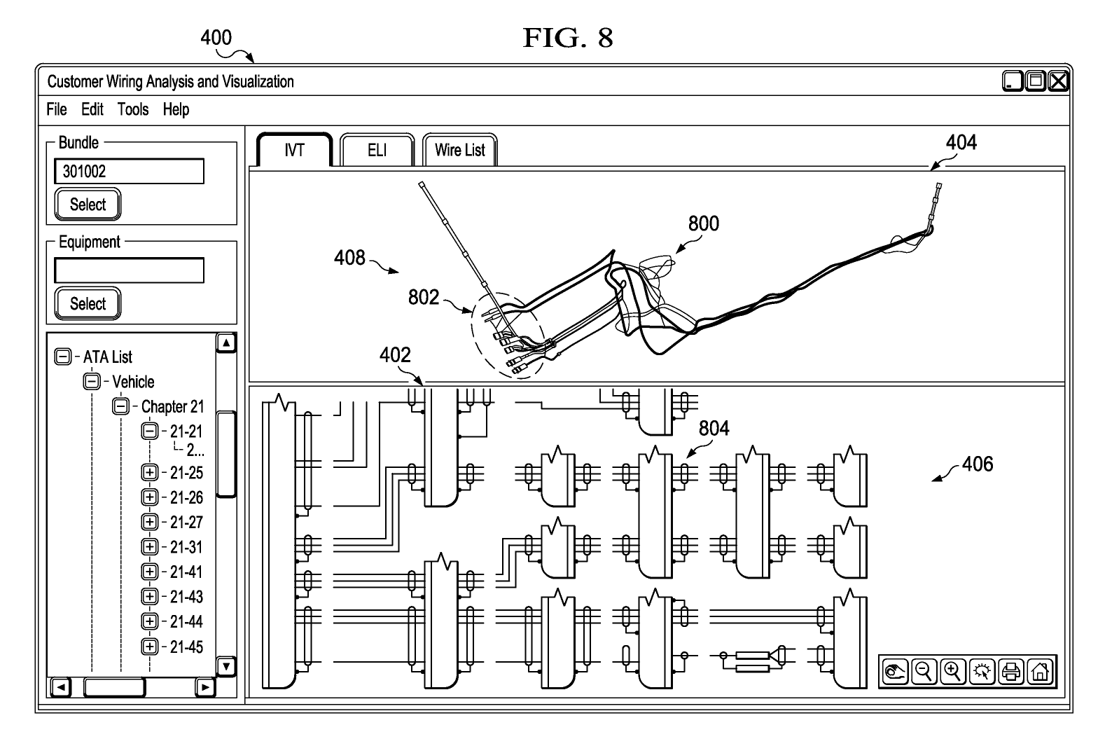

With reference now to FIG. 8, another illustration of interaction between two views of a wiring system is depicted in accordance with an advantageous embodiment. In this illustrative example, physical components 800 are displayed in two-dimensional view 406.

Physical components 800 are for a wiring system. In this depicted example, a selection of a portion of physical components 800 in three-dimensional view 408 filters which logical components for the system are displayed in two-dimensional view 406. In particular, the selection of portion 802 of physical components 800 in three-dimensional view 408 filters the logical components for the system such that only logical components 804 are displayed in two-dimensional view 406.

The illustration of graphical user interface 400 with two-dimensional view 406 and three-dimensional view 408 is not meant to imply limitations to the manner in which different advantageous embodiments may be implemented. For example, graphical user interface 400 displays two-dimensional view 406 and three-dimensional view 408 in a single window. In other illustrative examples, each view may be displayed in a separate window. Further, graphical indicators are associated with the components in this example. In particular, one graphical indicator is associated with each component.

In other illustrative examples, multiple graphical indicators may be used. For example, highlighting and flashing, color and line thickness, dashed lines and icons, and/or other suitable types of combinations of graphical indicators may be used. In other words, any type or number of graphical indicators may be used with the components to identify the components that correlate with each other in the two different views.

With reference now to FIG. 9, an illustration of a flowchart of a process for displaying wiring information is depicted in accordance with an advantageous embodiment. The process illustrated in FIG. 9 may be implemented in display module 106 in FIG. 1.

The process begins by displaying a first view of a wiring system in which logical components are displayed in the first view (operation 900). Thereafter, the process displays a second view of the wiring system in which physical components in the wiring system are displayed in the second view (operation 902).

The process then determines whether a user input has been received to the display of the wiring system from one view in the first view and the second view (operation 904). In one illustrative example, the user input is a selection of a component. In another example, the user input may be to filter the view for a particular function and/or system. In some cases, the user input may be to filter the view by a location of installation, a designer of the system, a date of installation, a presence of metadata for a particular part, and/or other suitable criteria.

If a user input has not been received, the process returns to operation 904. Otherwise, the process identifies a reaction based on the user input to the wiring system (operation 906). Operation 906 identifies a number of components in the other view. The other view is the view in which the user input was not received. If the user input was a selection of a component, the number of components is a component corresponding to the component selected. In contrast, if a corresponding component is not present, then a group of components associated with the selected component may be identified. The process then displays the reaction in another view other than the one view in which the user input was received to the display of the wiring system (operation 908), with the process then returning to operation 904.

The flowcharts and block diagrams in the different depicted embodiments illustrate the architecture, functionality, and operation of some possible implementations of apparatus and methods in an advantageous embodiment. In this regard, each block in the flowchart or block diagrams may represent a module, segment, function, and/or a portion of an operation or step. For example, one or more of the blocks may be implemented as program code, in hardware, or a combination of the program code and hardware. When implemented in hardware, the hardware may, for example, take the form of integrated circuits that are manufactured or configured to perform one or more operations in the flowcharts or block diagrams.

In some alternative implementations of an advantageous embodiment, the function or functions noted in the block may occur out of the order noted in the figures. For example, in some cases, two blocks shown in succession may be executed substantially concurrently, or the blocks may sometimes be executed in the reverse order, depending upon the functionality involved. Also, other blocks may be added in addition to the illustrated blocks in a flowchart or block diagram.

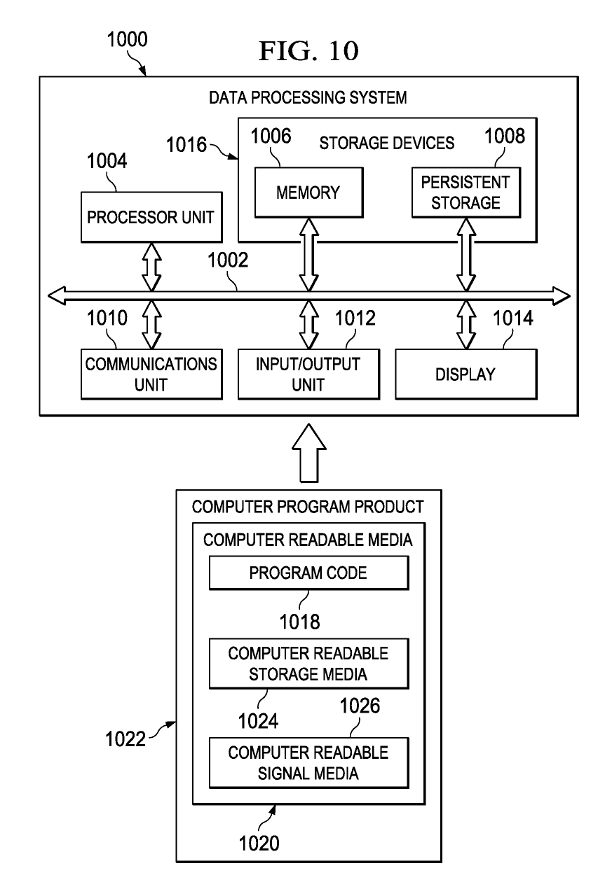

Turning now to FIG. 10, an illustration of a data processing system is depicted in accordance with an advantageous embodiment. In this illustrative example, data processing system 1000 includes communications fabric 1002 which provides communications between processor unit 1004, memory 1006, persistent storage 1008, communications unit 1010, input/output (I/O) unit 1012, and display 1014. Data processing system 1000 may be used to implement one or more of number of computers 104 in computer system 102 in these illustrative examples.

Processor unit 1004 serves to execute instructions for software that may be loaded into memory 1006. Processor unit 1004 may be a number of processors, a multi-processor core, or some other type of processor, depending on the particular implementation. A number, as used herein with reference to an item, means one or more items. Further, processor unit 1004 may be implemented using a number of heterogeneous processor systems in which a main processor is present with secondary processors on a single chip. As another illustrative example, processor unit 1004 may be a symmetric multi-processor system containing multiple processors of the same type.

Memory 1006 and persistent storage 1008 are examples of storage devices 1016. A storage device is any piece of hardware that is capable of storing information, such as, for example, without limitation, data, program code in functional form, and/or other suitable information either on a temporary basis and/or a permanent basis. Storage devices 1016 may also be referred to as computer readable storage devices in these examples. Memory 1006, in these examples, may be, for example, a random access memory or any other suitable volatile or non-volatile storage device. Persistent storage 1008 may take various forms, depending on the particular implementation.

For example, persistent storage 1008 may contain one or more components or devices. For example, persistent storage 1008 may be a hard drive, a flash memory, a rewritable optical disk, a rewritable magnetic tape, or some combination of the above. The media used by persistent storage 1008 also may be removable. For example, a removable hard drive may be used for persistent storage 1008.

Communications unit 1010, in these examples, provides for communications with other data processing systems or devices. In these examples, communications unit 1010 is a network interface card. Communications unit 1010 may provide communications through the use of either or both physical and wireless communications links.

Input/output unit 1012 allows for input and output of data with other devices that may be connected to data processing system 1000. For example, input/output unit 1012 may provide a connection for user input through a keyboard, a mouse, and/or some other suitable input device. Further, input/output unit 1012 may send output to a printer. Display 1014 provides a mechanism to display information to a user.

Instructions for the operating system, applications, and/or programs may be located in storage devices 1016, which are in communication with processor unit 1004 through communications fabric 1002. In these illustrative examples, the instructions are in a functional form on persistent storage 1008. These instructions may be loaded into memory 1006 for execution by processor unit 1004. The processes of the different embodiments may be performed by processor unit 1004 using computer implemented instructions, which may be located in a memory, such as memory 1006.

These instructions are referred to as program code, computer usable program code, or computer readable program code that may be read and executed by a processor in processor unit 1004. The program code in the different embodiments may be embodied on different physical or computer readable storage media, such as memory 1006 or persistent storage 1008.

Program code 1018 is located in a functional form on computer readable media 1020 that is selectively removable and may be loaded onto or transferred to data processing system 1000 for execution by processor unit 1004. Program code 1018 and computer readable media 1020 form computer program product 1022 in these examples. In one example, computer readable media 1020 may be computer readable storage media 1024 or computer readable signal media 1026.

Computer readable storage media 1024 may include, for example, an optical or magnetic disk that is inserted or placed into a drive or other device that is part of persistent storage 1008 for transfer onto a storage device, such as a hard drive, that is part of persistent storage 1008. Computer readable storage media 1024 also may take the form of a persistent storage, such as a hard drive, a thumb drive, or a flash memory, that is connected to data processing system 1000. In some instances, computer readable storage media 1024 may not be removable from data processing system 1000.

In these examples, computer readable storage media 1024 is a physical or tangible storage device used to store program code 1018 rather than a medium that propagates or transmits program code 1018. Computer readable storage media 1024 is also referred to as a computer readable tangible storage device or a computer readable physical storage device. In other words, computer readable storage media 1024 is a media that can be touched by a person.

Alternatively, program code 1018 may be transferred to data processing system 1000 using computer readable signal media 1026. Computer readable signal media 1026 may be, for example, a propagated data signal containing program code 1018. For example, computer readable signal media 1026 may be an electromagnetic signal, an optical signal, and/or any other suitable type of signal. These signals may be transmitted over communications links, such as wireless communications links, optical fiber cable, coaxial cable, a wire, and/or any other suitable type of communications link. In other words, the communications link and/or the connection may be physical or wireless in the illustrative examples.

In some advantageous embodiments, program code 1018 may be downloaded over a network to persistent storage 1008 from another device or data processing system through computer readable signal media 1026 for use within data processing system 1000. For instance, program code stored in a computer readable storage medium in a server data processing system may be downloaded over a network from the server to data processing system 1000. The data processing system providing program code 1018 may be a server computer, a client computer, or some other device capable of storing and transmitting program code 1018.

The different components illustrated for data processing system 1000 are not meant to provide architectural limitations to the manner in which different embodiments may be implemented. The different advantageous embodiments may be implemented in a data processing system including components in addition to or in place of those illustrated for data processing system 1000. Other components shown in FIG. 10 can be varied from the illustrative examples shown. The different embodiments may be implemented using any hardware device or system capable of running program code. As one example, the data processing system may include organic components integrated with inorganic components and/or may be comprised entirely of organic components excluding a human being. For example, a storage device may be comprised of an organic semiconductor.

In another illustrative example, processor unit 1004 may take the form of a hardware unit that has circuits that are manufactured or configured for a particular use. This type of hardware may perform operations without needing program code to be loaded into a memory from a storage device to be configured to perform the operations.

For example, when processor unit 1004 takes the form of a hardware unit, processor unit 1004 may be a circuit system, an application specific integrated circuit (ASIC), a programmable logic device, or some other suitable type of hardware configured to perform a number of operations. With a programmable logic device, the device is configured to perform the number of operations. The device may be reconfigured at a later time or may be permanently configured to perform the number of operations. Examples of programmable logic devices include, for example, a programmable logic array, a programmable array logic, a field programmable logic array, a field programmable gate array, and other suitable hardware devices. With this type of implementation, program code 1018 may be omitted because the processes for the different embodiments are implemented in a hardware unit.

In still another illustrative example, processor unit 1004 may be implemented using a combination of processors found in computers and hardware units. Processor unit 1004 may have a number of hardware units and a number of processors that are configured to run program code 1018. With this depicted example, some of the processes may be implemented in the number of hardware units, while other processes may be implemented in the number of processors.

In another example, a bus system may be used to implement communications fabric 1002 and may be comprised of one or more buses, such as a system bus or an input/output bus. Of course, the bus system may be implemented using any suitable type of architecture that provides for a transfer of data between different components or devices attached to the bus system.

Additionally, a communications unit may include a number of more devices that transmit data, receive data, or transmit and receive data. A communications unit may be, for example, a modem or a network adapter, two network adapters, or some combination thereof. Further, a memory may be, for example, memory 1006, or a cache, such as found in an interface and memory controller hub that may be present in communications fabric 1002.

Thus, the different advantageous embodiments provide a method and apparatus for displaying wiring information. With one or more of the different advantageous embodiments, an operator may more easily obtain information about wiring systems in different platforms. With the interaction between the first view and the second view, an operator may more easily see information needed.

In these illustrative examples, the first view is a two-dimensional view of the wiring system while the second view is a three-dimensional view of the wiring system. By selecting one or more components in the two-dimensional view, those corresponding components in the three-dimensional view may be seen. In some cases, the corresponding components may not be present and an associated component may be displayed. This association may be, for example, a wiring bundle for a wire in the three-dimensional view.

In some illustrative examples, selecting one or more components in the two-dimensional view may cause additional components to be seen in the three-dimensional view. For example, additional components, such as equipment, location information, and/or spatial information may be provided in the three-dimensional view.

Further, in this manner, an operator may be able to identify the location and positioning of different components in the platform after finding the components of interest based on the function or other information in the two-dimensional view. In a similar fashion, when a component is identified in the platform, the three-dimensional view may be used to select that component to find other information about the components in the two-dimensional view.

The description of the different advantageous embodiments has been presented for purposes of illustration and description and is not intended to be exhaustive or limited to the embodiments in the form disclosed. Many modifications and variations will be apparent to those of ordinary skill in the art.

For example, although the advantageous embodiments have been described with respect to a wiring system, some advantageous embodiments may be applied to other types of systems. These systems may be systems in which a flow is present. For example, the flow may be air, gas, light, water, oil, fuel, a hydraulic fluid, and/or other suitable elements that may flow. These systems may include, for example, a fuel system, a hydraulic system, an environmental system, an air handling system, an oil system, and/or other suitable types of systems. The different advantageous embodiments may be applied to provide a first view and a second view with interactions between the first view and the second view.

Further, these systems may be located on other platforms other than an aircraft. For example, these systems may be located on a submarine, a bus, a personnel carrier, tank, a train, an automobile, a spacecraft, a space station, a satellite, a surface ship, a power plant, a dam, a manufacturing facility, a building, and/or some other suitable object.

The application of the different advantageous embodiments to these different types of systems may take into account differences present between the types of systems. For example, the manner in which routing and rules for a wiring system are different from a hydraulic system are defined may be taken into account in applying the different advantageous embodiments to a hydraulic system.

In these illustrative examples, the different type of systems transports different types of things. For example, wiring system diagrams show the transport of electricity. The electricity may be electrical signals that encode information. In other cases, the electricity may supply power to different devices. As such, these systems use switches, signals, and connections that facilitate the transmission and transport of this type of content.

Other system diagrams, such as hydraulic systems show transport physical elements such as hydraulic fluids. This type of system does not carry multiple groups of elements, and the transport medium does not contain information as in wiring systems. However, the control mechanisms shown in these systems are designed with physical control elements, such as motors, pumps, valves, and actuators. Finally, these system types may also include wiring-based systems to effect the system controls. The manner in which interaction between views of these systems may be implemented may take into account these and possibly other differences between the systems.

Further, different advantageous embodiments may provide different advantages as compared to other advantageous embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A method for displaying wiring information, the method comprising:
displaying a first view of a wiring system in which logical components are displayed in the first view;
displaying a second view of the wiring system in which physical components in the wiring system are displayed in the second view; and
responsive to a user input to a display of the wiring system in one view from the first view and the second view, displaying a reaction in another view other than the one view from the first view and the second view based on the user input to the display of the wiring system.

2. The method of claim 1, wherein displaying the first view of the wiring system in which the logical components are displayed in the first view comprises:
displaying the first view of the wiring system in which the logical components are displayed in the first view in two dimensions.

3. The method of claim 1, wherein displaying the second view of the wiring system in which the physical components in the wiring system are displayed in the second view comprises:
displaying the second view of the wiring system in which the physical components in the wiring system are displayed in the second view in three dimensions.

4. The method of claim 1, wherein the reaction comprises alteration of a display of a number of components in the another view other than the one view from the first view and the second view based on the user input to the display of the wiring system.

5. The method of claim 1, wherein the user input is a selection of a wire in the first view and the reaction is a display of a graphical indicator in association with a wiring bundle containing the wire in the second view.

6. The method of claim 1, wherein the user input is a selection of a wiring bundle in the second view and the reaction is a display of graphical indicators in association with wires in the wiring bundle in the second view.

7. The method of claim 1, wherein the user input is a selection of a number of components in the first view for display from the wiring system on the first view without other components in the wiring system and the reaction is a display of components corresponding to the number of components in the second view without other components in the second view.

8. The method of claim 1, wherein the first view provides first information about the wiring system that is absent from the second view and the second view provides second information about the wiring system that is absent from the second view.

9. The method of claim 1, wherein the wiring system is located in an aircraft.

10. The method of claim 9, wherein displaying the second view of the wiring system in which the physical components in the wiring system are displayed in the second view comprises:
displaying the second view of the wiring system in which the physical components in the wiring system are graphically displayed with respect to locations of the physical components in the aircraft in the second view.

11. An apparatus comprising:
a computer system configured to display a first view of a wiring system in which logical components are displayed in the first view; display a second view of the wiring system in which physical components in the wiring system are displayed in the second view; and responsive to a user input to a display of the wiring system in one view from the first view and the second view, display a reaction in another view other than the one view from the first view and the second view based on the user input to the display of the wiring system.

12. The apparatus of claim 11, wherein in being configured to display the first view of the wiring system in which the logical components are displayed in the first view, the computer system is configured to display the first view of the wiring system in which the logical components are displayed in the first view in two dimensions.

13. The apparatus of claim 11, wherein in being configured to display the second view of the wiring system in which the physical components in the wiring system are displayed in the second view, the computer system is configured to display the second view of the wiring system in which the physical components in the wiring system are displayed in the second view in three dimensions.

14. The apparatus of claim 11, wherein the reaction comprise alteration of a display of a number of components in the another view other than the one view from the first view and the second view based on the user input to the display of the wiring system.

15. The apparatus of claim 11, wherein the user input is a selection of a wire in the first view and the reaction is a display of a graphical indicator in association with a wiring bundle containing the wire in the second view.

16. The apparatus of claim 11, wherein the user input is a selection of a wiring bundle in the second view and the reaction is a display of graphical indicators in association with wires in the wiring bundle in the second view.

17. The apparatus of claim 11, wherein the user input is a selection of a number of components in the first view for display from the wiring system on the first view without other components in the wiring system and the reaction is a display of components corresponding to the number of components in the second view without other components in the second view.

18. The apparatus of claim 11, wherein the first view provides first information about the wiring system that is absent from the second view and the second view provides second information about the wiring system that is absent from the second view.

19. The apparatus of claim 11, wherein the wiring system is located in an aircraft and wherein in being configured to display the second view of the wiring system in which the physical components in the wiring system are displayed in the second view, the computer system is configured to display the second view of the wiring system in which the physical components in the wiring system are graphically displayed with respect to locations of the physical components in the aircraft in the second view.

20. A computer program product comprising:
a computer readable storage medium;
first program code for displaying a first view of a wiring system in which logical components are displayed in the first view;
second program code for displaying a second view of the wiring system in which physical components in the wiring system are displayed in the second view; and
third program code, responsive to a user input to a display of the wiring system in one view from the first view and the second view, for displaying a reaction in another view other than the one view from the first view and the second view based on the user input to the display of the wiring system, wherein the first program code, the second program code, and the third program code are stored on the computer readable storage medium.
